(19) United States
(12) Patent Application Publication
(10) Pub. No.: US 2020/0370331 A1
(43) Pub. Date: Nov. 26, 2020

(54) APPARATUS FOR HEATING A DOOR LATCH

(71) Applicant: FORD GLOBAL TECHNOLOGIES, LLC, Dearborn, MI (US)

(72) Inventors: Prashant Dubey, Canton, MI (US); LaRon Michelle Brown, Detroit, MI (US); David Manuel Rogers, Ferndale, MI (US); Kosta Papanikolaou, Huntington Woods, MI (US); Livianu Dorin Puscas, Rochester Hills, MI (US)

(21) Appl. No.: 16/420,647

(22) Filed: May 23, 2019

(51) Int. Cl. E05B 17/00; E05B 85/02; H05B 1/02

(52) U.S. Cl. CPC E05B 17/0016; H05B 1/0236; E05B 85/02

(57) ABSTRACT

An apparatus includes a latch assembly, having a housing and a latch carried in the housing, a heating feature, and a rechargeable battery connected to the heating feature. That heating feature includes a thermoelectric cooler controller and a resistive heating element. The resistance heating element may be a heater film molded to a face of the housing.

### TECHNICAL FIELD

This document relates generally to the motor vehicle and autonomous vehicle fields and, more particularly, to a new and improved apparatus for heating a door latch assembly and ensuring proper operation of that door latch assembly in inclement winter weather conditions and sub-freezing temperatures.

### BACKGROUND

During inclement winter weather conditions with sub-freezing temperatures a door latch assembly may not operate as intended due to freezing water or condensation in the latch assembly.

This document relates to a new and improved apparatus especially configured or adapted to prevent a latch assembly from freezing during inclement winter weather conditions with sub-freezing temperatures.

### SUMMARY

In accordance with the purposes and benefits described herein, a new and improved apparatus is provided for heating a latch assembly and, more particularly, a door latch assembly on a motor vehicle or an autonomous vehicle. Advantageously the apparatus ensures proper operation of the latch assembly in inclement winter weather conditions including sub-freezing temperatures.

The apparatus comprises a latch assembly including a housing and a latch carried in the housing, a heating feature at least partially carried on the housing and a rechargeable battery connected to the heating feature.

In one particularly useful embodiment, the heating feature includes a thermoelectric cooler controller and a resistive heating element. That resistive heating element may be a heater film molded to a face of the housing of the latch assembly.

The apparatus may further include a control module adapted or configured for controlling the operation of the heating feature. That control module may include a controller having control logic configured to activate and deactivate the heating feature. Further, the control module may include a latch assembly temperature sensor providing current latch assembly temperature data to the controller as well as an ambient air temperature sensor providing ambient air temperature data to the controller.

More particularly, the control logic may be configured to activate the heating feature in response to the current latch assembly temperature data indicating a first current latch assembly temperature below a first threshold latch assembly temperature. That threshold latch assembly temperature may be, for example, 0 degrees C., 1 degree C., 2 degrees C., or any other temperature appropriate for indicating a potential latch assembly freezing condition.

Further, the control logic may be configured to deactivate the heating feature in response to the current latch assembly temperature data indicating a second current latch assembly temperature above a second threshold latch assembly temperature. That second threshold latch assembly temperature may be, for example, 3 degrees C., 4 degrees C., 5 degrees C. or other temperature above 0 degrees C.

In one possible embodiment the first threshold latch assembly temperature is lower than the second threshold latch assembly temperature. In another possible embodiment the first threshold latch assembly temperature is equal to the second threshold latch assembly temperature.

The control logic of the controller may also be configured to activate the heating feature in response to the current outside ambient air temperature data indicating a current outside ambient air temperature below a predetermined outside ambient threshold temperature such as, for example, 0 degrees C.

In addition, the control logic may be configured to activate the heating feature in response to a remote start signal received by the controller from a remote start actuator for the vehicle in which the apparatus is incorporated.

In accordance with an additional aspect, the apparatus comprises a latch assembly, including a housing and a latch carried in the housing, and a heating feature including a thermoelectric cooler controller and a resistive heating element. More particularly, the resistive heating element may be a heater film molded to a face of the housing. In such an embodiment the housing may include an inner face oriented toward the latch and an outer face oriented away from the latch. The heater film may be molded to the outer face.

In accordance with yet an additional aspect, the apparatus may comprise a latch assembly, including a housing and a latch carried in the housing, and a heating feature including a thermoelectric cooler controller and a resistive heating element wherein the resistive heating element is carried on a face of the housing. The resistance heating element may be a heater film molded to a face of the housing. Further, the apparatus may include a control module controlling operation of the heating feature. Such a control module may include a controller having control logic configured to activate and deactivate the heating feature in response to changes in current ambient air temperature and changes in current latch assembly temperature.

In the following description, there are shown and described several preferred embodiments of the apparatus. As it should be realized, the apparatus is capable of other, different embodiments and its several details are capable of modification in various, obvious aspects all without departing from the apparatus as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the apparatus and together with the description serve to explain certain principles thereof.

FIG. 1 is a schematic block diagram of the apparatus.

FIG. 2 is a perspective illustration of a door assembly incorporating the heated latch assembly of the apparatus.

FIG. 3 is a detailed elevational view of the heating feature carried on the housing of the latch assembly of the apparatus.

FIG. 4 is a logic flow diagram for the apparatus.

Reference will now be made in detail to the present preferred embodiments of the apparatus, examples of which are illustrated in the accompanying drawing figures.

### DETAILED DESCRIPTION

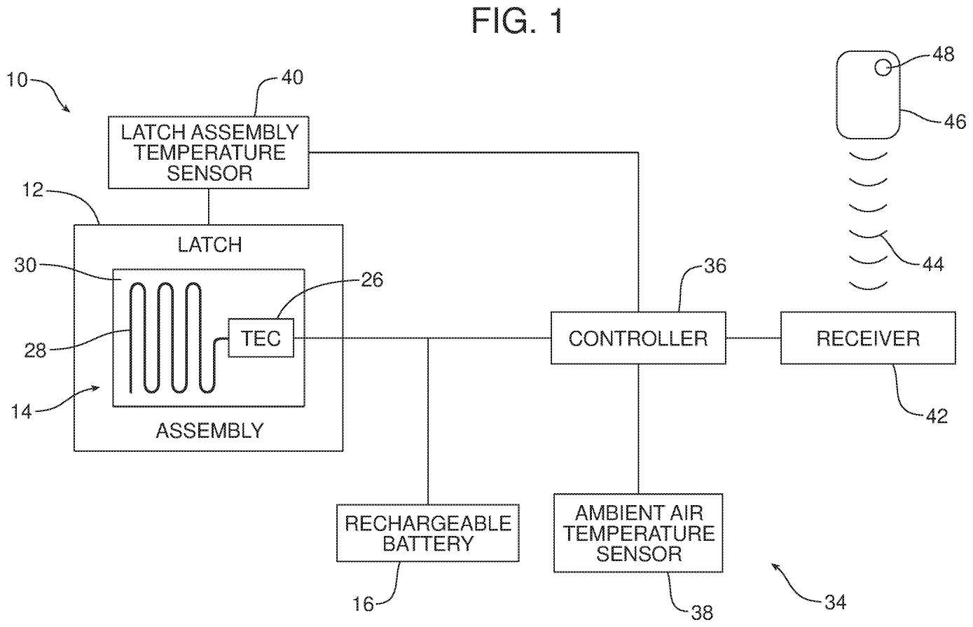

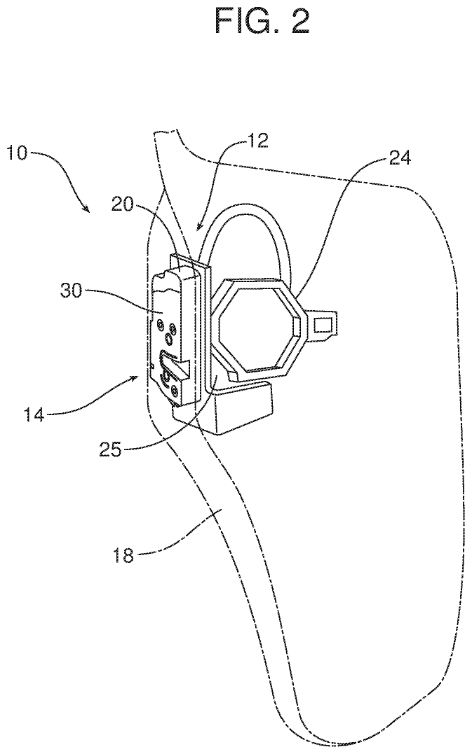

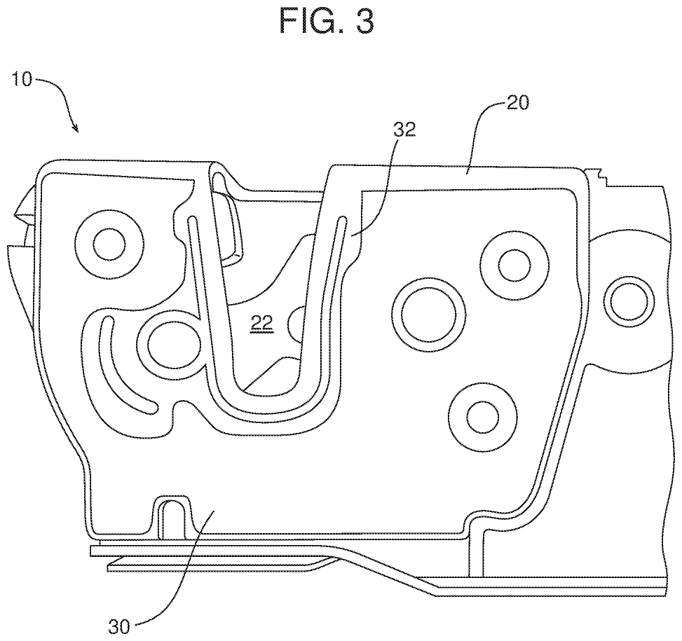

Reference is now made to FIG. 1 schematically illustrating a new and improved apparatus 10. That apparatus 10 may be generally described as including a latch assembly 12, a heating feature 14 carried on the latch assembly and a rechargeable battery 16 connected to the heating feature. More particularly, as best illustrated in FIG. 2, the latch assembly 12 may be carried on a door 18 of a motor or autonomous vehicle (not shown). As illustrated in FIG. 3, the latch assembly 12 may include a housing 20 and a releasable latch 22 carried in the housing. The latch 22 may be operated by a latch control module 24 of a type known in the art. As illustrated in FIG. 2, that latch control module 24 may be carried on the door 12 behind the latch assembly 12. The rechargeable battery 16 may be carried on the door 18 in the space 25 between the latch assembly 12 and the door control module 24. The rechargeable battery 16 may be recharged through connection with the latch control module 24.

As illustrated in schematically in FIG. 1, the heating feature 14 may include a thermoelectric cooler controller (TEC) 26 connected to a resistive heating element 28. The resistive heating element 28 may take the form of a thin copper wire held in a film of polymeric material 30, such as thermoplastic polyurethane. Here it should be appreciated that the heating element 14 may be over molded or insert molded on a face 32 of the housing 20 and, more particularly, the outer face of the housing oriented away from the latch 22 (see FIG. 3).

Referring back to FIG. 1, the apparatus 10 may also include a control module generally designated by reference numeral 34, that controls the operation of the heating feature 14. More particularly, in the illustrated embodiment, the control module 34 includes a controller 36, an ambient air temperature sensor 38 and a latch assembly temperature sensor 40. The controller 36 comprises a computing device, such as a dedicated microprocessor or an electronic control unit (ECU) operating in accordance with instructions from appropriate control software. Such a controller 36 includes one or more processors, one or more memories, and one or more network interfaces, all in communication with each other over a communication bus.

The ambient air temperature sensor 38 is of a type known in the art that is adapted to detect current ambient air temperature and provide current ambient air temperature data to the controller 36. The latch assembly temperature sensor 40 is also of a type known in the art and adapted to detect the current latch assembly temperature and provide data with respect to the current latch assembly temperature to the controller 36.

As additionally shown in FIG. 1, the controller 36 is also connected to a receiver 42 which is adapted to receive a wireless remote start signal 44 from a key fob 46 or other such device carried by the motor vehicle operator. In the illustrated embodiment, the key fob 46 includes a remote start actuator 48 in the form of a push button.

The control module 34 controls operation of the resistive heating element 28 carried on the housing 20 of the latch assembly 12. More particularly, the controller 36 of the control module 34 has control logic configured to activate and deactivate the heating feature 14. In at least one of the many possible embodiments of the apparatus 10, the control logic of the controller 36 is configured to activate the heating feature 14 in response to the current latch assembly temperature data received from the current latch assembly temperature sensor 40 indicating a first current latch assembly temperature below a first threshold latch assembly temperature. Further, the control logic of the controller 36 may be configured to deactivate the heating feature 14 in response to the current latch assembly temperature data received from the current latch assembly temperature sensor 40 indicating a second current latch assembly temperature above a second threshold latch assembly temperature. In many embodiments, the first threshold latch assembly temperature is lower than the second threshold latch assembly temperature but in some embodiments the first and second threshold latch assembly temperatures may be equal.

Typically, the first latch assembly temperature is indicative of a potential freezing condition wherein a moisture in the latch assembly 12 freezes and potentially prevents proper operation thereof. Thus, the first threshold latch assembly temperature may be, for example, 0 degrees C., 1 degree C., 2 degrees C., 3 degrees C., 4 degrees C. or 5 degrees C. Typically the second threshold latch assembly temperature is 2 or more degrees above the first threshold latch assembly temperature.

The control logic of the controller 36 may also be configured to activate the heating feature 14 in response to current outside ambient temperature data received from the current ambient air temperature sensor 38 indicating a current outside ambient air temperature below a predetermined outside ambient threshold temperature. That outside ambient threshold temperature may be, for example, the temperature at which water freezes, 0 degrees C., or within a few degrees above that temperature.

In still other embodiments, the control logic of the controller 36 is configured to activate the heating feature 14 in response to the remote start signal 44 being received at the receiver 42 and thereby by the controller 36 when the remote start actuator 48 on the key fob 46 is depressed.

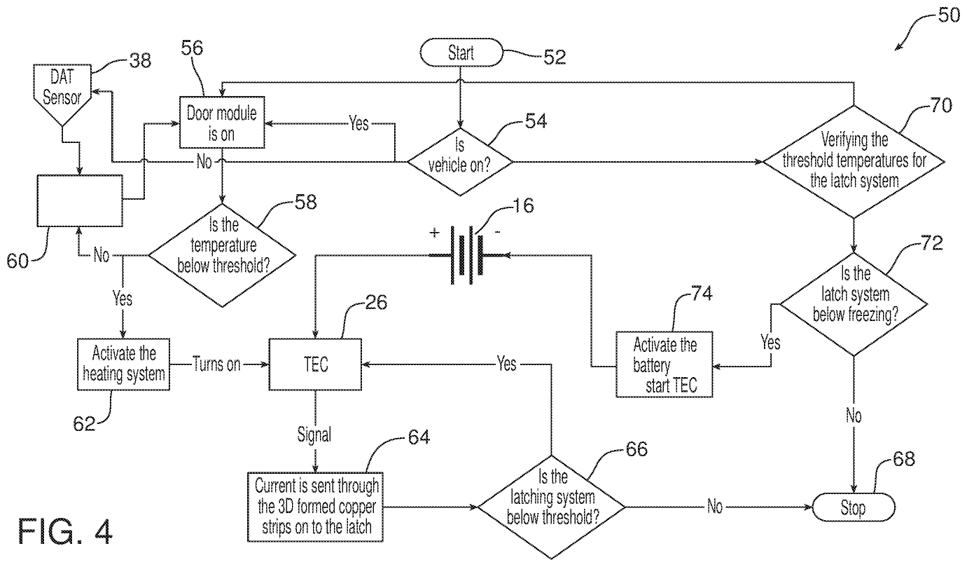

Reference is now made to FIG. 4 illustrating one possible logic flow diagram 50 for the apparatus 10. That control logic flow diagram 50 is initiated at the start box 52 which directly leads to the controller 36 querrying whether the vehicle ignition is on at box 54. If the vehicle ignition is on, the door module 24 is also on at box 56. Next, the controller 36 queries whether or not the current outside ambient air temperature is below the predetermined outside ambient air threshold temperature at box 58. The current ambient outside air temperature is determined by the ambient air temperature sensor 38 which provides that data to the body control module (BCM) 60 of the motor vehicle which in turn provides that data to the controller 36 through the CAN gateway of the vehicle not shown. If the current outside ambient air temperature data is not below the threshold, the BCM 60 and controller 36 continue to monitor the current outside ambient air temperature based upon data received from the outside ambient air temperature sensor 38. In the event the current outside ambient air temperature data indicates that the current outside ambient air temperature has fallen below the threshold value, the controller 36 activates the heating system of the vehicle at box 62 which, in turn, turns on or activates the thermoelectric cooler controller 26. The thermoelectric cooler controller 26 causes current from the battery 16 to be sent through the heating element 28 at box 64 thereby heating the latch assembly 12. The controller 36 monitors the current temperature of the latch assembly based upon current latch assembly temperature data provided by the latch assembly temperature sensor 40 to the controller (see box 66). If the current latch assembly temperature data indicates a latch assembly temperature below the second threshold latch assembly temperature, heating continues. In contrast, once the current latch assembly temperature data indicates a current latch assembly temperature above the second threshold value, heating is terminated at box 68.

The control logic flow diagram 50 also illustrates the backup system that may be operated periodically or at a predetermined selected time by the motor vehicle user (e.g. at a particular time of day before the user leaves for work in the morning). Thus, the backup system periodically verifies the current latch assembly temperature at box 70 based upon data provided by the latch assembly temperature sensor 40. If the current latch assembly temperature is below freezing (see box 72) the system is activated at box 74 so that power from the battery 16 is delivered to the thermoelectric cooler controller 26 which in turn initiates heating of the latch assembly 12 by application of current through the resistive heating element 28 at box 64. The controller 36 continues to monitor the current temperature of the latch assembly at box 66. So long as that temperature remains below the threshold value heating continues. However, once the current latch assembly temperature is above the threshold value heating is terminated at box 68. This action ensures that the latch assembly 12 is maintained at a temperature that prevents function failure due to winter temperature extremes that might otherwise cause a freezing condition.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An apparatus, comprising:
a latch assembly including a housing and a latch carried in said housing;
a heating feature at least partially carried on said housing; and
a rechargeable battery connected to said heating feature.

2. The apparatus of claim 1, wherein said heating feature includes a thermoelectric cooler controller and a resistive heating element.

3. The apparatus of claim 2, wherein said resistive heating element is a heater film molded to a face of said housing.

4. The apparatus of claim 3, further including a control module controlling operation of said heating feature.

5. The apparatus of claim 4, wherein said control module includes a controller having control logic configured to activate and deactivate said heating feature.

6. The apparatus of claim 5, wherein said control module further includes a latch assembly temperature sensor providing current latch assembly temperature data to said controller.

7. The apparatus of claim 6, wherein said control logic is configured to activate said heating feature in response to said current latch assembly temperature data indicating a first current latch assembly temperature below a first threshold latch assembly temperature.

8. The apparatus of claim 7, wherein said control logic is configured to deactivate said heating feature in response to said current latch assembly temperature data indicating a second current latch assembly temperature above a second threshold latch assembly temperature.

9. The apparatus of claim 8, wherein said first threshold latch assembly temperature is lower than said second threshold latch assembly temperature.

10. The apparatus of claim 8, wherein said first threshold latch assembly temperature is equal to said second threshold latch assembly temperature.

11. The apparatus of claim 6, wherein said control module further includes an outside ambient temperature sensor providing current outside ambient air temperature data to said controller.

12. The apparatus of claim 11, wherein said control logic is configured to activate said heating feature in response to said current outside ambient air temperature data indicating a current outside ambient air temperature below a predetermined outside ambient threshold temperature.

13. The apparatus of claim 12, wherein said control logic is configured to activate said heating feature in response to a remote start signal received by said controller from a remote start actuator for a vehicle.

14. An apparatus, comprising:
a latch assembly including a housing and a latch carried in said housing; and
a heating feature including a thermoelectric cooler controller and a resistive heating element wherein said resistive heating element is carried on said housing.

15. The apparatus of claim 14, wherein said resistive heating element is a heater film molded to a face of said housing.

16. The apparatus of claim 15, wherein said housing includes an outer face oriented away from said latch, said heater film being molded to said outer face.

17. An apparatus, comprising:
a latch assembly including a housing and a latch carried in said housing; and
a heating feature including a thermoelectric cooler controller and a resistive heating element wherein said resistive heating element is carried on a face of said housing.

18. The apparatus of claim 17, wherein said resistive heating element is a heater film molded to a face of said housing.

19. The apparatus of claim 18, further including a control module controlling operation of said heating feature.

20. The apparatus of claim 19, wherein said control module includes a controller having control logic configured to activate and deactivate said heating feature in response to changes in current ambient air temperature and changes in current latch assembly temperature.
